(19) United States
(12) Patent Application Publication
(10) Pub. No.: US 2026/0203956 A1
(43) Pub. Date: Jul. 16, 2026

(54) Multi-Realism Image Compression With a Conditional Generator

(71) Applicant: Google LLC, Mountain View, CA (US)

(72) Inventors: Eirikur Agustsson, Gardabaer (IS); George Toderici, Mountain View, CA (US); Fabian Mentzer, Zurich (CH); David Minnen, San Carlos, CA (US)

(21) Appl. No.: 19/135,286

(22) PCT Filed: Dec. 14, 2023
(86) PCT No.: PCT/US2023/083970

§ 371 Date: Jun. 3, 2025

Related U.S. Application Data
(60) Provisional application No. 63/433,028, filed on Dec. 16, 2022.

(51) Int. Cl. G06T 9/00; G06N 3/0455; G06N 3/0464

(52) U.S. Cl. CPC G06T 9/002; G06N 3/0455; G06N 3/0464

(57) ABSTRACT

A bitstream that includes an encoded representation of a source image is obtained. A realism factor indicative of an amount of synthesized content in a reconstructed image of the source image is received. The realism factor and the encoded representation are input to a decoder to obtain the reconstructed image of the source image. The reconstructed image is store or displayed. The encoded representation can be a latent space representation of the source image and is created by an encoder. The realism factor can be derived from a range of values indicative of desired perceptual qualities in the reconstructed image.

### TECHNICAL FIELD

This disclosure relates to image reconstruction, specifically to a decoder that obtains multiple image reconstructions along a distortion-realism continuum from the same encoded representation.

### SUMMARY

This disclosure relates to image reconstruction, specifically to a decoder that obtains multiple image reconstructions along a distortion-realism continuum from the same encoded representation.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method. The method includes obtaining a bitstream that includes an encoded representation of a source image. The method also includes receiving a realism factor indicative of an amount of synthesized content in a reconstructed image of the source image. The method also includes inputting the realism factor and the encoded representation to a decoder to obtain the reconstructed image of the source image. The method also includes storing or displaying the reconstructed image. Other embodiments of this aspect include corresponding computer systems, apparatus, and computer programs recorded on one or more computer storage devices, each configured to perform the actions of the methods.

Implementations may include one or more of the following features. The method where the encoded representation may include a latent space representation of the source image and is created by an encoder. The decoder can be a generator of a Generative Adversarial Network (GAN). The realism factor is obtained as input from a user. The generator can include a plurality of convolution layers, and where the realism factor is injected into at least some of the convolution layers. The realism factor can be a value in a range that includes a first value and a second value and other values between the first value and the second value, where the first value indicates that the reconstructed image includes no synthesized content and the second value indicates that the reconstructed image does not include synthesized content. A level of synthesized content in the reconstructed image can be based on the realism factor. The bitstream can be obtained via a compression process that includes a hyper-prior-based autoencoder. The method may include: applying a machine-learning entropy model to the bitstream prior to obtaining the encoded representation. The realism factor can be derived from a range of values indicative of desired perceptual qualities in the reconstructed image. Implementations of the described techniques may include hardware, a method or process, or computer software on a computer-accessible medium.

Another general aspect includes a method. The method includes receiving a source image. The method also includes encoding the source image using an autoencoder to generate an encoded representation, where the autoencoder may include a hyperprior-based architecture. The method also includes conditioning a generator on a realism factor to produce a reconstructed image from the encoded representation, where the realism factor is adjustable to control a level of synthesized content in the reconstructed image. The method also includes storing or transmitting the encoded representation along with the realism factor. Other embodiments of this aspect include corresponding computer systems, apparatus, and computer programs recorded on one or more computer storage devices, each configured to perform the actions of the methods.

Implementations may include one or more of the following features. The method where conditioning the generator on the realism factor to produce the reconstructed image from the encoded representation may include: processing the realism factor through a feature-generator to obtain a set of realism-factor features; and inputting the realism-factor features to the generator. Processing the realism factor through the feature-generator to obtain the set of the realism-factor features may include: processing the realism factor through a multilayer perceptron (MLP) to generate the realism-factor features. The reconstructed image can vary from a low mean squared error (MSE) reconstruction to a high perceptual quality reconstruction based on the realism factor. The generator can be part of a generative adversarial network (GAN). The reconstructed image can be evaluated against a real image by a discriminator within the GAN. The generator can be trained using a loss function that includes a rate-distortion component and a realism component. Implementations of the described techniques may include hardware, a method or process, or computer software on a computer-accessible medium.

Some implementations include a non-transitory computer-readable storage medium, comprising executable instructions that, when executed by a processor, facilitate performance of operations that perform any of the methods described herein.

Details of the above implementations and variations thereof are described below with respect to the detailed description, the drawings, and the appended claims.

### BRIEF DESCRIPTION OF THE DRAWINGS

The disclosure is best understood from the following detailed description when read in conjunction with the accompanying drawings. It is emphasized that, according to common practice, the various features of the drawings are not-to-scale. On the contrary, the dimensions of the various features are arbitrarily expanded or reduced for clarity.

FIG. 1 is a block diagram of a traditional encoder.

FIG. 2 is a block diagram of a traditional decoder.

FIG. 3 illustrates a comparison between a distortion-based reconstruction and a realism-based reconstruction.

FIG. 4 is an example of a generic Generative Adversarial Network (GAN).

FIG. 5 is a diagram of multi-realism image compression with a conditional generator.

FIG. 6 is a diagram of an example of an architecture of a GAN for multi-realism image compression.

FIG. 7 is a flowchart of a method or technique for obtaining a reconstructed image of a source image.

FIG. 8 is a flowchart of a method or technique for encoding a source image such that different reconstructions can be obtained based on a realism factor.

FIG. 9 is a block diagram of an example of a computing device.

### DETAILED DESCRIPTION

Lossy image compression considers the trade-off between the number of bits used to store an input image (which may be a frame of a video stream) and how close the reconstruction (obtained from the bits) is to that input image. As more bits are used, the closer the reconstructed image will be to the source image. This concept is formalized or is known as the rate-distortion tradeoff.

A rate-distortion value (RD) refers to a ratio that balances an amount of distortion (e.g., a loss in image quality) with rate (e.g., a number of bits) for coding an image (e.g., blocks therein). If R denotes the rate, and D denotes the distortion, then the cost of encoding can be given by: cost=R+λD. Some codecs may refer to the multiplier λ as the Lagrange multiplier (denoted λ_{mode}); other codecs may use a similar multiplier that is referred as rdmult. This multiplier is related to and may derived from the quantization parameter (QP). Each codec may have a different method of calculating the multiplier due in part to the fact that the different codecs may have different meanings (e.g., definitions, semantics, etc.) for, and methods of use of, quantization parameters. The parameter/may also be referred as a “rate parameter.”

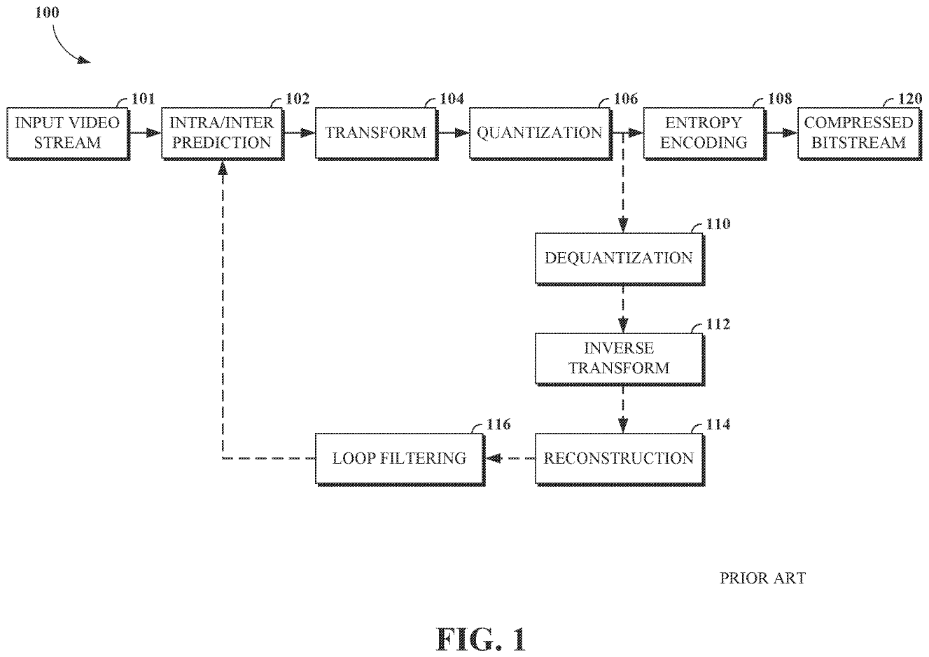

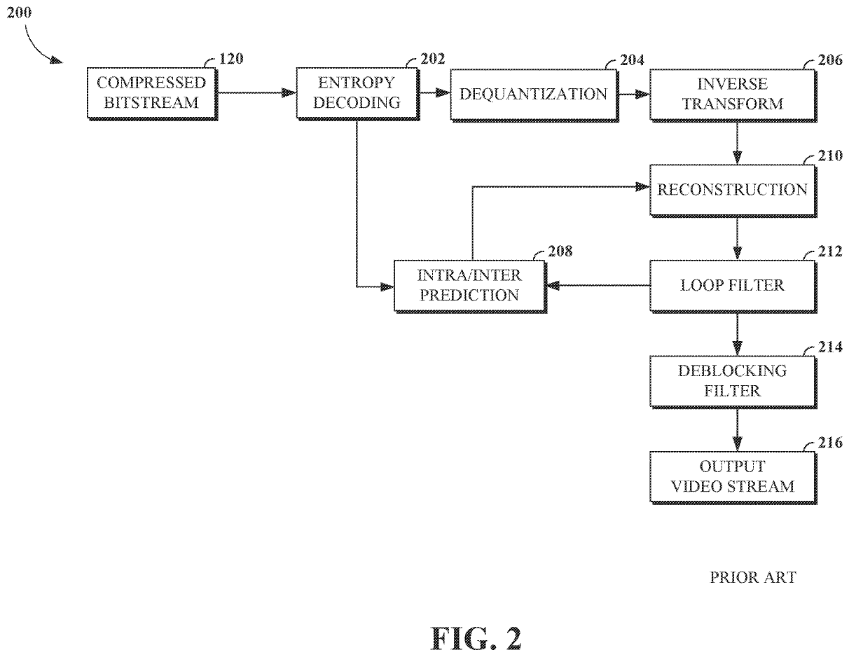

A prediction scheme that minimizes the rate-distortion value to encode an image block may be selected for encoding the image block. The amount of distortion between the reconstructed image and the source image can be measured using an error measure, such as a mean square error (MSE) between pixel values of the reconstructed image and the source image, a sum of absolute differences (SAD), or some other suitable error measure. A traditional encoder and a traditional decoder that use the rate-distortion tradeoff are described with respect to FIG. 1 and FIG. 2, respectively. As is known, stages similar to at least some of those described with respect to FIGS. 1 and 2 can be implemented by codecs that implement image compression standards, such as the Joint Photographic Experts Group (JPEG) standard.

When a low bit rate is used to compress and reconstruct images using codecs such as those described with respect to FIGS. 1 and 2 (e.g., codecs that use rate-distortion tradeoffs), undesirable artifacts (e.g., blocking artefacts) can appear in reconstructed images. Realism in image reconstruction can provide an alternative to the rate-distortion-based reconstruction.

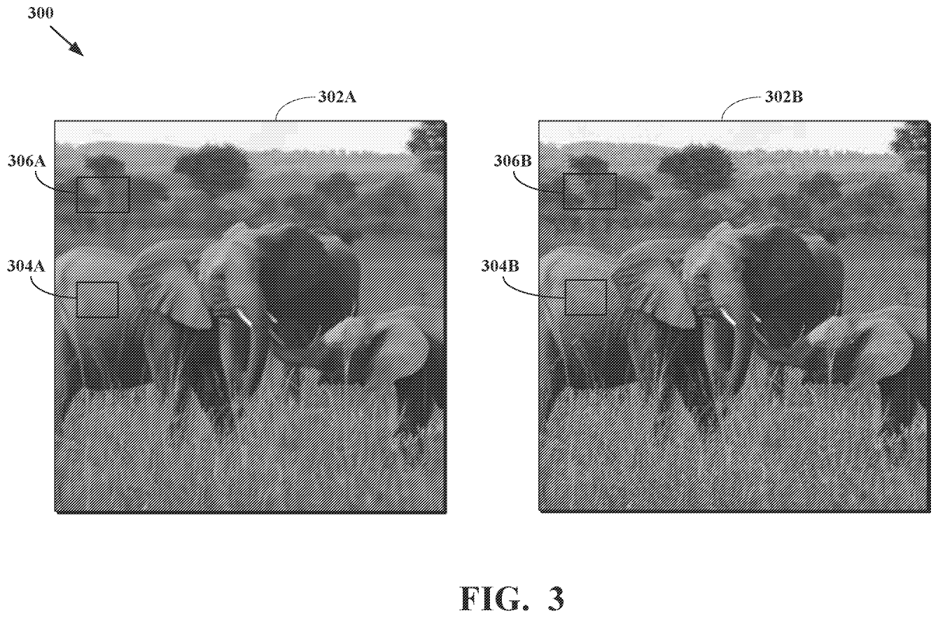

Realism refers to the perceptual quality of a reconstructed image. Intuitively, a person may prefer a realistic-looking reconstruction of an image rather than a reconstruction that includes undesirable artefacts. A “realistic” reconstruction may be a sharp and appropriately textured reconstruction. A realistic reconstruction may have a worse error measure (e.g., MSE) than an average image obtained using rate-distortion based techniques. However, users might find a realism-based reconstruction more perceptually pleasing and less artificial. Generating a reconstructed image based on rate-distortion considerations is referred to herein as a distortion-based reconstruction; and generating a reconstructed image based on realism considerations is referred to herein as realism-based reconstruction. FIG. 3 illustrates a comparison between a distortion-based reconstruction and a realism-based reconstruction. The terms “realism” and “perception” can be used interchangeably. As contrasted with “perceptual quality,” which is used more generally as a measure of subjective visual quality, the terms “realism” and “perception” refer to a divergence between distributions over images, as further described herein.

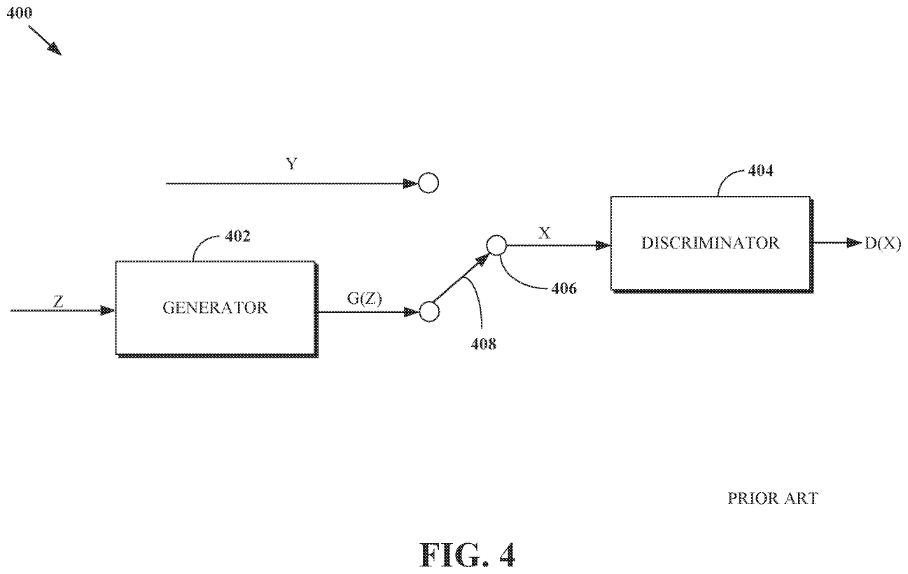

A realism-based reconstruction can use, can be implemented, or can be realized using a GAN. GANs are a class of machine-learning (ML) models that can be used to generate (i.e., synthesize) new data. To illustrate, amongst other applications, GANs can be used to generate new images, to generate high-resolution images from low-resolution images, or to reconstruct lost or deteriorated parts of images and/or videos. The basic principles of GANs are described with respect to FIG. 4.

As illustrated in FIG. 4, realism- or generative-based compression approaches can produce detailed, realistic images, even at low bit rates, instead of blurry reconstructions produced by rate-distortion optimized models. However, a problem exists with image compression that optimize based on realism and do not explicitly control the level (e.g., amount) of synthesized content in a reconstructed image. With such techniques, there is a concern that a misleading reconstruction that is far (in terms of content) from the source input image may be generated. That is, a reconstructed image may include an unknown and/or unacceptable level of synthesized (i.e., generated) content and/or it may not be clear which details are in the source image and which were added in the reconstructed image.

Implementations according to this disclosure can be used to explicitly control how much detail is synthesized by training a decoder (i.e., a generator G of a GAN) that can bridge the distortion-based reconstruction and the realism-based regimes and can be said to navigate the distortion-realism trade-off. From a single encoded (e.g., compressed) representation, the decoder can be used to obtain a low MSE reconstruction that is close to the source input, a realistic reconstruction with high perceptual quality, or any reconstruction that is in between on the distortion-realism continuum. Implementations according to this disclosure achieve better distortions at high realism and better realism at low distortion than previous techniques that optimize for one vs. the other.

To reiterate, given a single encoded representation, a decoder is trained to produce a reconstruction where little or no detail is generated (as in the case of rate-distortion optimized codecs), a reconstruction where fine-grained detail is generated (as in the case rate-distortion-realism optimized codecs), or anything in between. How much detail (i.e., the amount of realism) is to be generated is determined at decode time. The amount of realism is controlled by an input (i.e., a realism factor) to the decoder. The decoder (and not the encoder) is conditioned on the “realism factor,” (denoted β, herein). As such, the full spectrum of reconstructions can be generated from a single compressed representation, ŷ, by the decoder.

As is known, distortion-based compression techniques use the Peak signal-to-noise ratio (PSNR) as a measure of performance. PSNR can be indicative of and is a function of the MSE (between a source image and a reconstructed image) as a sum over all squared value differences (for at least some of the color channels) divided by image size and by number of color channels. The Fréchet inception distance (FID) can be used as a measure of realism to assess the quality of images generated by a generator of a GAN. Briefly, to calculate the FID measure, each of a source image and a generated therefrom are converted to a feature space to obtain respective feature data (e.g., respective feature vectors). The respective feature data are used to compare the respective statistics of the source image data compared with the statistics of the generated image (i.e., the reconstruction of the source image). As such, FID can be described as comparing the statistics of respective feature data.

Implementations according to this disclosure can achieve better distortions measures (better PSNR values) at high realism (i.e., low FID) and better realism (better FID values) at low distortion (i.e., high PSNR) than other image coding techniques.

FIG. 1 is a block diagram of a traditional encoder 100. The encoder 100 has the following stages to perform the various functions in a forward path (shown by the solid connection lines) to produce an encoded or compressed bitstream 120 using a video stream 101 as input: an intra/inter prediction stage 102, a transform stage 104, a quantization stage 106, and an entropy encoding stage 108. The encoder 100 may also include a reconstruction path (shown by the dotted connection lines) to reconstruct a frame for encoding of future blocks. In FIG. 1, the encoder 100 has the following stages to perform the various functions in the reconstruction path: a dequantization stage 110, an inverse transform stage 112, a reconstruction stage 114, and a loop filtering stage 116. Other structural variations of the encoder 100 can be used to encode the video stream 101.

When the video stream 101 is presented for encoding, respective frames of the video stream, can be processed in units of blocks. At the intra/inter prediction stage 102, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 1, the prediction block can be subtracted from the current block at the intra/inter prediction stage 102 to produce a residual block (also called a residual). The transform stage 104 transforms the residual into transform coefficients in, for example, the frequency domain using block-based transforms. The quantization stage 106 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 108. The entropy-encoded coefficients, together with other information used to decode the block, which may include for example the type of prediction used, transform type, motion vectors and quantizer value, are then output to the compressed bitstream 120. The compressed bitstream 120 can be formatted using various techniques, such as variable length coding (VLC) or arithmetic coding. The compressed bitstream 120 can also be referred to as an encoded video stream or encoded video bitstream, and the terms will be used interchangeably herein.

The reconstruction path in FIG. 1 (shown by the dotted connection lines) can be used to ensure that the encoder 100 and a decoder 200 (described below) use the same reference frames to decode the compressed bitstream 120. The reconstruction path performs functions that are similar to functions that take place during the decoding process that are discussed in more detail below, including dequantizing the quantized transform coefficients at the dequantization stage 110 and inverse transforming the dequantized transform coefficients at the inverse transform stage 112 to produce a derivative residual block (also called a derivative residual). At the reconstruction stage 114, the prediction block that was predicted at the intra/inter prediction stage 102 can be added to the derivative residual to create a reconstructed block. The loop filtering stage 116 can be applied to the reconstructed block to reduce distortion such as blocking artifacts.

Other variations of the encoder 100 can be used to encode the compressed bitstream 120. For example, a non-transform-based encoder can quantize the residual signal directly without the transform stage 104 for certain blocks or frames. In another implementation, an encoder can have the quantization stage 106 and the dequantization stage 110 combined in a common stage.

FIG. 2 is a block diagram of a traditional decoder 200. The decoder 200, similar to the reconstruction path of the encoder 100 discussed above, includes in one example the following stages to perform various functions to produce an output video stream 216 from the compressed bitstream 120: an entropy decoding stage 202, a dequantization stage 204, an inverse transform stage 206, an intra/inter prediction stage 208, a reconstruction stage 210, a loop filtering stage 212 and a deblocking filtering stage 214. Other structural variations of the decoder 200 can be used to decode the compressed bitstream 120.

When the compressed bitstream 120 is presented for decoding, the data elements within the compressed bitstream 120 can be decoded by the entropy decoding stage 202 to produce a set of quantized transform coefficients. The dequantization stage 204 dequantizes the quantized transform coefficients (e.g., by multiplying the quantized transform coefficients by the quantizer value), and the inverse transform stage 206 inverse transforms the dequantized transform coefficients to produce a derivative residual that can be identical to that created by the inverse transform stage 112 in the encoder 100. Using header information decoded from the compressed bitstream 120, the decoder 200 can use the intra/inter prediction stage 208 to create the same prediction block as was created in the encoder 100, e.g., at the intra/inter prediction stage 102. At the reconstruction stage 210, the prediction block can be added to the derivative residual to create a reconstructed block. The loop filtering stage 212 can be applied to the reconstructed block to reduce blocking artifacts.

Other filtering can be applied to the reconstructed block. In this example, the deblocking filtering stage 214 is applied to the reconstructed block to reduce blocking distortion, and the result is output as the output video stream 216. The output video stream 216 can also be referred to as a decoded video stream, and the terms will be used interchangeably herein. Other variations of the decoder 200 can be used to decode the compressed bitstream 120. For example, the decoder 200 can produce the output video stream 216 without the deblocking filtering stage 214.

FIG. 3 illustrates a comparison 300 between a distortion-based reconstruction and a realism-based reconstruction. FIG. 3 shows a distortion-based reconstructed image 302A and a realism-based reconstructed image 302B of a source image (not shown). The distortion-based reconstructed image 302A is reconstructed from an image representation that is based on minimizing an error measure (e.g., an MSE). The realism-based reconstructed image 302B is reconstructed from an image representation that is based on minimizing FID.

The realism-based reconstructed image 302B includes smooth content (such as areas 304A and 306A) that do not look realistic because they do not include any texture. On the other hand, the corresponding areas 304B and 306B appear more realistic to a person. However, some of the content of the realism-based reconstructed image 302B may be synthesized (e.g., generated) content that may not have been part of the source image.

FIG. 4 is an example of a generic GAN 400. The GAN 400 includes a generator 402 and a discriminator 404. A purpose of the GAN 400 is such that, through training (i.e., after the training is complete), the generator 402 can generate realistic data (e.g., generated, realistic images) such that the discriminator 404 cannot tell that the data is generated. That is, the discriminator 404 considers (i.e., is fooled into considering) the generated data to be real data.

The generator 402 can be an inverse convolutional network that receives a vector Z of data (which, in an example, may be a vector of random noise), and up-samples the vector Z to generate the generated data (e.g., generated image), G(Z). The generator 402 can be thought of as a function that maps the input Z to an output G(Z). The discriminator 404 can be a convolutional network that can categorize the input that is fed to it, along an input 406, into as either real or fake (i.e., generated).

In an example, given an input X, the discriminator 404 outputs a label, D(X), indicating whether the input X is real or generated. The discriminator 404 can be a binomial classifier that can label (e.g., classify) an input X as real or generated. For example, D(X) can be 0 if the discriminator 404 determines that the input X is generated; otherwise D(X) can be 1. Other output values can be possible. In another example, D(X) can be a probability value.

As illustrated by a switch 408, the discriminator 404 can receive, as an input X, either the output G(Z) of the generator 402 or a real data sample Y. When the discriminator 404 receives G(Z) as input (i.e., when X=G(Z)), the output of the discriminator 404 is a value, D(G(Z)), indicating whether the discriminator 404 considers the input G(Z) to be real or generated. When the discriminator 404 receives Y as input (i.e., when X=Y), the output of the discriminator 404 is a value, D(Y), indicating whether the discriminator 404 considers the input Y to be real or generated.

The generator 402 and the discriminator 404 networks can be thought of as working together and, at the same time, working against each other. Colloquially, the generator 402 can be thought of a counterfeiter and the discriminator 404 can be thought of as a cop. The counterfeiter's purpose (during the training) is to generate data such that the cop cannot recognize that the generated data are counterfeit.

The generator 402 is trained to maximize the probability D(G(Z)) of fooling the discriminator 404 so that the discriminator 404 is not able to tell that G(Z) is generated. The discriminator 404 is trained to minimize the probability D(G(Z)) and maximize the probability D(Y) so that the generated sample G(Z) can be distinguished from a real data sample Y. When a real input Y is fed into the discriminator 404, the goal of the discriminator 404 is to output, for example, a probability D(X)=1; and to output a D(X)=0 if the input is generated (e.g., G(X)). Again, D(X) can be the probability that the input X is real (i.e., P (class of input=real data)).

The end result is that when both the generator 402 and the discriminator 404 converge, the discriminator 404 can no longer distinguish the generated sample G(Z) from a real data sample Y. At this point, the generator 402 can be regarded as having learned the distribution of the real data Y. By convergence is meant that additional training of either of the generator 402 and/or the discriminator 404 does lead to improved (or sufficiently improved) performance.

Backpropagation can be used to improve the performance of each of the generator 402 and the discriminator 404 networks.

As mentioned, the discriminator 404 can output a value D(X) indicating the chance that the input X is a real data sample. The objective of the discriminator 404 is to maximize the chance of recognizing real data samples (i.e., Y) as real and the chance of recognizing that generated samples (i.e., G(Z)) as fake (i.e., generated). That is, the goal of the discriminator 404 is to maximize the likelihood of the inputs. To measure the loss, cross-entropy, p log (q), can be used. The cross-entropy loss is a measure of how accurately the discriminator identified real and generated samples (e.g., images). Optimizing the weights Op of the discriminator 404 can be expressed by the optimization problem of equation (1):

$${θ}_{D}^{*} = {arg}_{{θ}_{D}} {max}_{{θ}_{D}} {𝔼}_{{P}_{y}} [ log {D}_{{θ}_{D}} ( y ) ] + {𝔼}_{{P}_{z}} [ log ( 1 - {D}_{{θ}_{D}} ( {G}_{{θ}_{G}} ( z ) ) ) ] \qquad ( 1 )$$

In equation (1), [symbol] means the expectation value with respect to the distribution of variable Y (i.e., a real data sample), [symbol] means the expectation value with respect to the distribution of variable Z (i.e., the vector Z from which G(Z) is generated), and θ_{D} and θ_{G} are the current network weight parameters of the discriminator 404 (D) and the generator 402 (G) respectively. D_{θ}_{_{D}}(y) is the output of the discriminator 404 given the current discriminator network parameters θ_{D} when the input Y (i.e., a real data sample) is presented to the discriminator 404. D_{θ}_{_{D}}(G_{θ}_{_{G}}(z)) is the output of the discriminator 404 given the current discriminator network parameters θ_{D} when the input G_{θ}_{_{G}}(z) (which, in turn, is the output of the generator 402 given the current generator network parameter θ_{G} when the input z is presented to the generator 402) is presented to the discriminator 404.

The equation (1) (i.e., the objective function of the discriminator 404) can be summarized as: find a new set of discriminator network parameters,

$${θ}_{D}^{*} ,$$

that maximizes the ability of the discriminator 404 to recognize real data samples better (i.e., corresponding to the term [symbol] [log D_{θ}_{_{D}}(y)]) and to recognize generated data samples better (i.e., corresponding to the term [symbol] [log (1−D_{θ}_{_{D}}(G_{θ}_{_{G}}(z)))).

Training the generator 402 can also be via backpropagation. The objective function of the generator 402, as mentioned above, can be such that the generator 402 generates data (e.g., images) with the highest possible value of D(x) to fool the discriminator 404. As such, the objective function of the generator G can be given by equation (2):

$${θ}_{G}^{*} = {arg}_{{θ}_{G}} {min}_{{θ}_{G}} {𝔼}_{{P}_{z}} [ log ( 1 - {D}_{{θ}_{D}} ( {G}_{{θ}_{G}} ( z ) ) ) ] \qquad ( 2 )$$

[symbol] and D_{θ}_{_{D}}(G_{θ}_{_{G}}(z)) are as described with respect to equation (1). Equation (2) can be summarized as: Find the optimal parameters of the generator 402, G, so that an output G(Z) of the generator 402 can fool the discriminator 404 the most.

The equations (1) and (2) can be combined into the minmax optimization problem:

$$( {θ}_{G}^{*} , {θ}_{D}^{*} ) = {arg}_{( {θ}_{G} , {θ}_{D} )} {min}_{{θ}_{G}} {max}_{{θ}_{D}} {𝔼}_{{P}_{y}} [ log {D}_{{θ}_{D}} ( y ) ] + {𝔼}_{{P}_{z}} [ log ( 1 - {D}_{{θ}_{D}} ( {G}_{{θ}_{G}} ( z ) ) ) ]$$

In an example, the objective functions of equations (1) and (2) can be learned jointly, such as by alternating gradient ascent and descent of the discriminator 404 and the generator 402, respectively. For example, the parameters, θ_{G}, of the generator 402 can be fixed and a single iteration of gradient ascent on the discriminator 404 can be performed using the real (i.e., Y) and the generated (i.e., G_{θ}_{_{G}}(z)) data samples; then the parameters, θ_{D}, of the discriminator 404 are fixed and the generator 402 can be trained for another single iteration of gradient descent. The discriminator 404 and the generator 402 networks can be trained in alternating steps until the generator 402 produces samples, G(Z), that the discriminator 404 cannot recognize as generated samples.

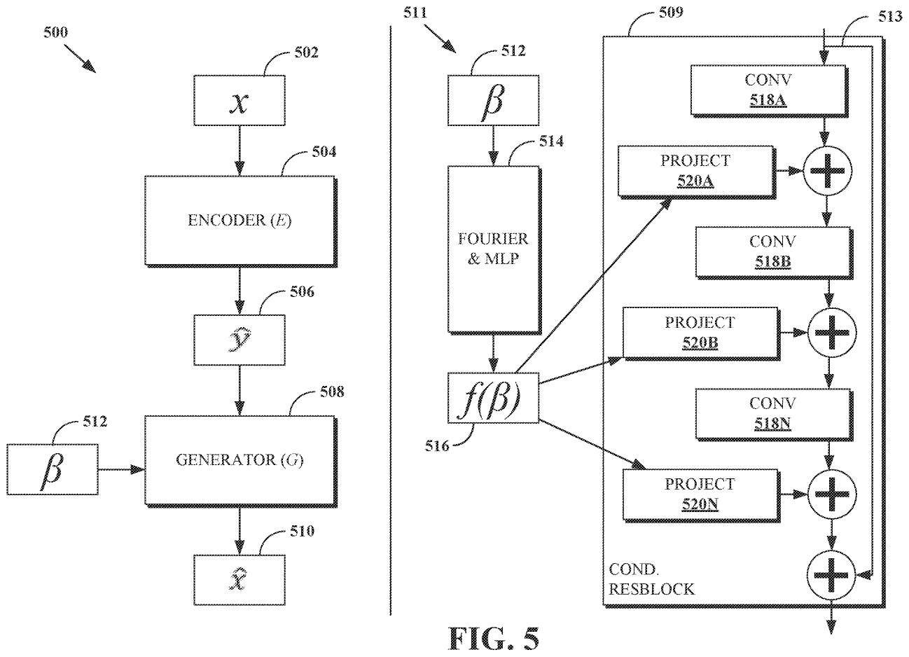

FIG. 5 is a diagram 500 of multi-realism image compression with a conditional generator. The diagram 500 includes an encoder 504 (denoted E) and a generator 508 (denoted G). Briefly, the encoder 504 obtains compressed representations of source images and the generator 508 (i.e., a decoder) obtains reconstructions of the source images from their respective compressed representations.

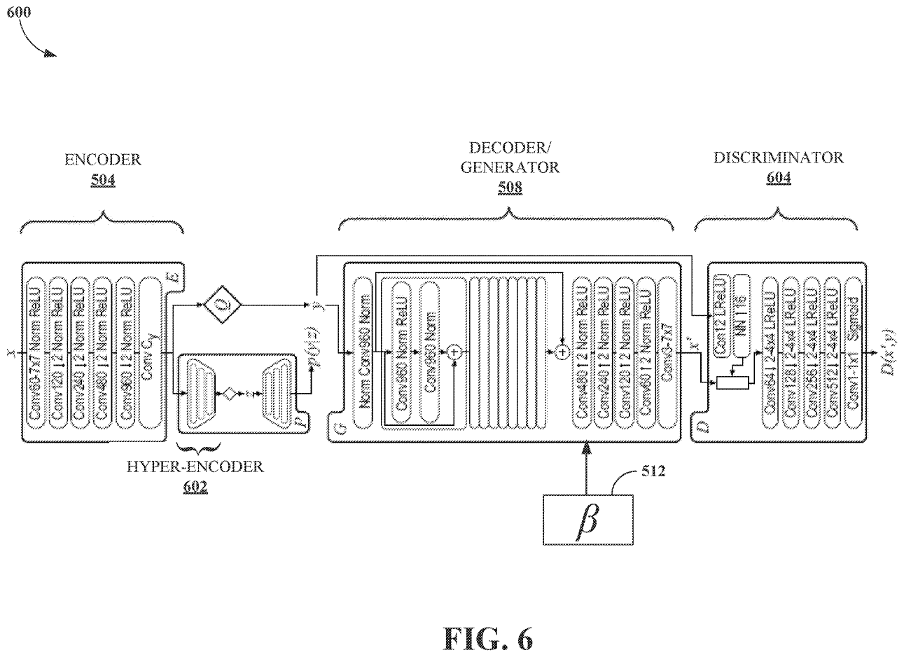

A source image 502 (denoted x) is input to the encoder 504, which maps the source image 502 to an encoded representation 506, denoted ŷ=E(x). The encoder 504 is a non-linear transform of, or can be considered to apply a non-linear transform to, the source image 502. The encoded representation 506 is a lossy, quantized representation of the source image 502. In an example, the encoded representation 506 can be further processed by a separate machine-leaning entropy model (which can be the hyper-encoder 602 described with respect to FIG. 6) to losslessly encode the representation 506 into a bitstream. In either case, the encoded representation 506 can be considered to be a quantized encoded representation of the source image 502.

Each of the encoder 504 and a generator 508 can be a Deep Neural Network (DNN). In an example, the encoder 504 and a generator 508 can be based on the ELIC architecture described in Dailan He, Ziming Yang, Weikun Peng, Rui Ma, Hongwei Qin, and Yan Wang, “ELIC: Efficient learned image compression with unevenly grouped space-channel contextual adaptive coding”, in Proceedings of the IEEE/CVF Conference on Computer Vision and Pattern Recognition, pages 5918-5927, 2022. 1, 3, 4, 5, 6, 7, 11, 12, which is incorporated herein by reference in its entirety. Whereas ELIC uses N=192 channels, the generator 508 can be wider (e.g., N=256). Additionally, and as described herein, the generator 508 is conditioned on the realism factor 512 to obtain a β-conditional generator G(ŷ, β). As such, to obtain a reconstruction given a representation ŷ, a chosen β value (β∈[0, βₘₐₓ]) is input to the generator 508 to obtain \hat{x}=G(ŷ, β). In an example, the chosen β may be selected by a user. In another example, the generator 508 may be configured with one or more values of the realism factor 512. As such, the generator 508 can output respective reconstructions for the realism factor values.

The encoded representation 506 (i.e., the quantized representation ŷ) is a latent space representation of the source image 502. The encoder 504 extracts image features through operations such as filtering, striding, pooling, and non-linear rectifying. The features become more abstract as the DNN layers get deeper. The source image 502 can be regarded as existing in a high m-dimensional ambient space. The encoder 504 maps the ambient space of the source image 502 from the m-dimensional space to a lower n-dimensional latent space, where n≤m.

The reverse mapping, from the latent space to the ambient space can be performed by the generator 508. The generator 508 is (or can be considered to perform) an inverse transformation on the encoded representation 506. The generator 508 receives the encoded representation 506 and outputs a reconstruction 510 (denoted x) of the source image 502. The encoded representation 506 has a reduced dimensionality as compares to the source image. To illustrate, whereas the source image may be of size W×H pixels and includes three color channels resulting in a dimensionality of W*H*3, the encoded representation may have a dimensionality of

$$\frac{W}{16} * \frac{H}{16} * 320 ,$$

which is smaller in dimensionality than the source image. As already mentioned, the encoded representation is a quantized representation. Thus, obtaining the encoded representation from the source image is a lossy operation.

The generator 508 is conditioned on a realism factor 512 (denoted β), which is input to the generator 508. As further described herein, the realism factor 512 is used by (i.e., is input to) the generator 508 at the time that the generator 508 is to generate the reconstruction 510 from the encoded representation 506 and during training of the generator 508.

The realism factor 512 controls the level of realism that the generator 508 is to generate (e.g., introduce or inject) into the reconstruction 510. That is, the realism factor 512 can be used by the generator 508 to control the level (e.g., extent, amount, etc.) of synthesized (e.g., added or generated) content in the reconstruction 510. Said yet another way, the realism factor 512 can be said to determine how realistic vs. how close to the source image 502 is the reconstruction 510. For example, the realism factor 512 may be used to control the level of blurriness vs. a level of synthesized content in the reconstruction 510.

As such, the generator 508 can be considered to be a multi-realism decoder because the generator 508 can generate different levels of synthetic content based on the value of the realism factor 512. Referring briefly to FIG. 3, in the case that β=0, the generator 508 may generate the distortion-based reconstructed image 302A, which has a good PSNR (i.e., low MSE) of 28.1 dB; and in the case that the realism factor 512 is a set to a maximum value (e.g., β=2.56), the generator 508 may generate the realism-based reconstructed image 302B, which is a sharper (e.g., more textured) reconstruction than the distortion-based reconstructed image 302A, but has a PSNR of 27.0 dB (which is lower by 1.1 dB than the PSNR of the distortion-based reconstructed image 302A).

How the realism factor 512 is used by the generator 508 is further described with respect to a diagram 511 of FIG. 5. The diagram 511 includes a residual block 509 that in turn includes three convolution layers (i.e., convolution layers 518A, 518B, 518N). However, the generator 508 may include more than one residual block and each of the residual blocks may include more or fewer convolution layers. It is also noted that the term “residual block” used with respect to FIG. 5 refers to a different construct and a different concept that those used with respect to FIGS. 1 and 2. With respect to neural networks, and as is known, residual blocks can be used to add skip-connections between layers (as illustrated with an arrow 513).

The diagram 511 illustrates how the realism factor 512 can be made to interact with (e.g., to influence) the activations of at least some of the neural network nodes of at least some of the layers of the generator 508. As an input to the generator 508, the encoded representation 506 (ŷ) can be considered to be an activation tensor. This tensor is to be processed through the convolution layers 518A, 518B, 518N of the residual block 509 until the reconstruction \hat{x} (i.e., the reconstruction 510) is obtained.

As such, without the realism factor 512, the encoded representation 506 would undergo a series of convolutions that recreate the reconstruction 510 from the representation 506. However, the diagram 511 illustrates that the realism factor 512, 8, is added (e.g., injected) through projections 520A, 520B, . . . , 520N. That is the residual blocks of the residual block 509 are conditioned on the realism factor 512.

The realism factor 512 is processed through a feature-generator 514 to obtain a set of realism-factor features 516, (denoted ƒ(β)). In an example, a d-dimensional embedding of the realism factor 512 β can be obtained using Fourier features. An n-layer multilayer perceptron (MLP) can be applied to the Fourier features to obtain features representing the realism factor 512: ƒ(β)=MLP(Fourier(β)). The Fourier features can be obtained as described in Ben Mildenhall, Pratul P Srinivasan, Matthew Tancik, Jonathan T Barron, Ravi Ramamoorthi, and Ren Ng. Nerf, “Representing scenes as neural radiance fields for view synthesis,” in Communications of the ACM, 65(1): 99-106, 2021, incorporated herein by reference in its entirety. In an example, the MLP can be a 2-layer MLP with rectified linear activation functions (i.e., ReLU activations) and 512 channels for each of the two dense layers.

As such, the feature-generator 514 generates a tensor (i.e., realism-factor features 516, (denoted ƒ(β)) from the realism factor 512. The realism-factor features 516, ƒ(β), represent different viewpoints of the single number (i.e., the realism factor 512). The projections 520A, 520B, 520N can be learned during the training of the generator 508.

As can be appreciated, each of the convolution layers 518A, 518B, 518N can have varying channels (i.e., varying output cardinalities). As such, each of the projections 520A, 520B, 520N can be or perform a respective linear transformation. Each of the projections 520A, 520B, 520N receives the realism-factor features 516 and changes the dimensionality of the realism-factor features 516 to match the dimensionality of the output of the one of the convolution layers 518A, 518B, 518N with which the realism-factor features 516 (i.e., the projection therefor) is to be added. To illustrate, the convolution layers 518A, 518B, 518N may have 200, 300, 700 channels, respectively. As such, the projections 520A, 520B, 520N project the realism-factor features 516 onto 200, 300, 700 channels, respectively. More generally, assuming that the i^{th} convolution layer in the residual block 509 has Cᵢ channels, then the realism-factor features 516, ƒ(β), are projected to Cᵢ channels with a learned (per layer) weight Wᵢ, therewith obtaining Wᵢ×ƒ(β) that is to be added to the output of the convolution layer.

FIG. 6 is a diagram of an example of an architecture of a GAN 600 for multi-realism image compression. The GAN 600 includes the encoder 504 of FIG. 5, a hyper-encoder 602, the generator 508 of FIG. 5, and a discriminator 604 (denoted D).

The hyper-encoder 602 (which can be a neural network) can be used to generate a conditional entropy model for entropy encoding the code symbols representing input data (such as the encoded representation 506 of FIG. 5). The hyper-encoder 602 can be configured to process the encoded representation 506 to generate a “hyper-prior,” (i.e., a latent representation of the conditional entropy model). In one example, the hyper-encoder 602 may be a convolutional neural network, and the hyper-prior may be a multi-channel feature map output by the final layer of the hyper-encoder 602. The hyper-prior can implicitly characterize an input data-dependent entropy model that enable the code symbols representing the input data to be efficiently compressed.

The training of the encoder 504 and the generator 508 are now described. In an example, the encoder 504 and the generator 508 may be trained for (e.g., may be specific to) a particular target bitrate. In another example, the encoder 504 and the generator 508 may be trained to support multiple bitrates.

As described with respect to FIG. 4, training the encoder 504 and the generator 508 includes training the discriminator 604. “Realism” can be thought of as a divergence, d(pₓ,p_{\hat{x}}), between a distribution of real images pₓ and reconstructions p_{\hat{x}}, therefor. A GAN-based loss can be used to estimate and to minimize this divergence during training. In addition to E (i.e., the encoder 504) and G (i.e., the generator 508), a conditional discriminator D(ŷ, x) (i.e., the discriminator 604) is trained to predict the probability that a given image x is a realistic image (i.e., is a source image) corresponding to a encoded representation y. As such, the conditional discriminator D (i.e., the discriminator 604) receives as input a source image x (e.g., the source image 502) and an encoded representation ŷ (e.g., the encoded representation 506). To emphasize, typically, only an image reconstruction (e.g., G (y)=\hat{x}) may be input to a discriminator D of the GAN 600. However, the conditional discriminator D (i.e., the discriminator 604) used herein (with respect to multi-realism image compression) also receives the quantized encoded representation (i.e., y).

The conditional discriminator D can be or can be similar to the patch discriminator described in U.S. Patent Publication No. US2022/0174328, which is incorporated herein by reference in its entirety, and referred to herein as the HiFiC technique. Briefly, the patch discriminator D does not output only one probability value for the whole of the input. Rather, the patch discriminator D may output a heatmap (or a similar data structure) that indicates, for groups of pixels, respective probabilities indicating how real the patch discriminator D believes the group of pixels to be. In an example, each group of pixels includes only one pixel. As such, the discriminator 604 can output a heatmap that includes one probability value per pixel. A GAN that uses a patch discriminator D is typically referred to as a patch GAN.

The loss functions used for the encoder 504 and the discriminator 604 can be as given by equations (3) and (4), respectively, and can be as described in the HiFiC technique.

$${ℒ}_{G} = {𝔼}_{y ∼ {P}_{y}} [ - log ( D ( \hat{y} , G ( \hat{y} ) ) ) ] \qquad ( 3 )$$

$${ℒ}_{D} = {𝔼}_{y ∼ {P}_{y}} [ - log ( 1 - D ( \hat{y} , G ( \hat{y} ) ) ) ] + {𝔼}_{x ∼ {P}_{x}} [ - log D ( E ( x ) , x ) ) ] \qquad ( 4 )$$

Equation (3) illustrates that the objective of the generator 508 is related to realism. The loss function used for training the generator 508 relates to the extent to which the discriminator 604 believes that reconstructions (i.e., \hat{x}=G(ŷ)) generated by the generator 508, when receiving encoded representations ŷ as input, are realistic reconstructions (i.e., include synthetic content). Said another way, the expectation value indicates how realistic G(ŷ) is; or, conversely, the probability that G(ŷ) is a real image (as opposed to being a synthesized image). A “real image” means an image that does not include synthetic (i.e., generated) content. Based on the loss, the generator 508 improves its ability to fool the discriminator 604 into believing that the images generated by the generator are real images consistent with the encoded representation 506, ŷ. The generator 508 improves its ability by adjusting its weights (such as via backpropagation). The image generated by the generator G cannot simply be any realistic image. Rather, the generator G generates a realistic image consistent with a corresponding encoded representation.

The loss function of equation (4) can be used to train the discriminator 604 to accurately discriminate between source (e.g., original) and reconstructed training images. The loss function of equation (4) depends on the difference between the classification (i.e., [symbol] [−log (1−D(ŷ, G(ŷ)))]) by the discriminator 604 of reconstructed images of the training data (i.e., and the classification (i.e., [symbol] [−log D(E(x),x))]) of ground truth (e.g., source or original) training images. Again, the classification by the discriminator D is conditioned on the encoded representation ŷ.

The loss function of the GAN-based multi-realism image compression system described herein, as a whole (e.g., the combination of the encoder 504 and the generator 508), can be as given by equation (5).

$${ℒ}_{EG} ( β ) = {𝔼}_{x ∼ {p}_{x}} [ {λ}^{′} r ( \hat{y} ) + d ( x , {\hat{x}}_{β} ) + β ( - log ( D ( \hat{y} , {\hat{x}}_{β} ) + {C}_{P} {ℒ}_{P} ( x , {\hat{x}}_{β} ) ) ] \qquad ( 5 )$$

As can be seen in equation (5), the loss function is conditioned on (e.g., includes or is a function of) the realism factor 512, β. d(x, \hat{x}_{β}) can be set to

$$\frac{1}{100} MSE ( x , {\hat{x}}_{β} ) ,$$

where MSE is calculated on inputs and reconstructions scaled to {0, . . . , 255}, and λ′=100λ, wherein λ is the rate parameter described above. As can be recognized, the term (λ′r(y)+d(\hat{x}_{β})) of equation (5) is the rate-distortion cost, which is what the GAN (e.g., the combination of the source image 502 and the generator 508) optimizes when realism is to be ignored or is not used (e.g., when β=0). When realism is not used, the system learns to optimize based on a combination of bitrate and MSE. As such, the GAN learns that as β approaches βₘₐₓ, the output of the discriminator 604 is to be considered to the extent of β; however, when β is 0, the discriminator 604 is ignored and its loss function does not contribute to the loss of the GAN-based compression system and that the focus of the GAN-based compression system should be on rate-distortion loss.

With respect to the term β(−log (D(ŷ,\hat{x}β)), when realism (but not multi-realism) is to be learned, then β can be set to a constant value. However, when multi-realism is desired, then β can be a sampled random variable that is in the range [0, βₘₐₓ]. As the value β approaches 0, the loss value becomes more based on (e.g., skewed toward) the MSE value (i.e., the rate-distortion value) and less based on the output of the discriminator 604. That is, the GAN is skewed towards an improved PSNR than FID. On the other hand, as the value β approaches βₘₐₓ, then the loss value becomes less based on the MSE value (i.e., the rate-distortion value) and more based on the output of the discriminator 604.

To restate, during training, the realism factor β can be uniformly sampled and [symbol] (β) is minimized. As mentioned herein, a single β value may control the weight in the loss between realism and low distortion. However, by sampling β uniformly, the generator 508 can be optimized to perform well, on average, for all possible points in the continuum between low-distortion (β=0) and high realism (β=5.12). βₘₐₓ can be set to a predefined value (e.g., βₘₐₓ=5.12). At inference time (i.e., at decode time), β can be freely chosen to navigate the distortion-realism trade-off to obtain different reconstructions \hat{x}_{β} from a fixed encoded representation y. At inference time, βₘₐₓ can have a different value than the βₘₐₓ used during training. For example, βₘₐₓ=2.56 (=5.12/2).

The term Cₚ [symbol] (x, \hat{x}_{β}) of equation (5) is referred to as a “perceptual term” and can be as described with respect to the HiFiC technique. Briefly, perceptual loss is a kind of loss that is commonly used in super resolution and in compression. Perceptual loss is similar to MSE but it is in the feature space.

The networks (the encoder 504, the generator 508, and discriminator 604) are characterized by their convolutional layers, indicated by a “Conv” prefix, which denotes the number of channels (C), the size of the kernels, and the stride for upsampling (“↑”) or downsampling (“↓,”). To illustrate, within the encoder 504, a particular layer employs 240 channels, and may utilize 3×3 kernels, and features a downsampling stride set to 2. This structured approach to layer specification is consistent across the network designs.

As is known, “ReLU” refers to the rectified linear unit activation function, while “LReLU” denotes the leaky version of ReLU with a preset alpha value (e.g., 0.2). The “Sigmoid” function may also be used as an activation function within these networks. An upsampling layers (denoted “NN↑”) may employ nearest neighbor techniques with particular (e.g., 4×4) size factors. “Norm” stands for “ChannelNorm” and performs normalization across channels rather than across both space and batches, or space and channels as is done by BatchNorm and LayerNorm layers, respectively.

The discriminator 604 can be a single-scale discriminator that incorporates spectral normalization layers. The discriminator 604 can be configured to act as a conditional discriminator, capable of making predictions about the classifications of network inputs based on a compressed representation y. The discriminator 604 receives a combination of a training data item (x or a reconstruction x′) and an upscaled version of the compressed representation y, allowing for conditioned classification.

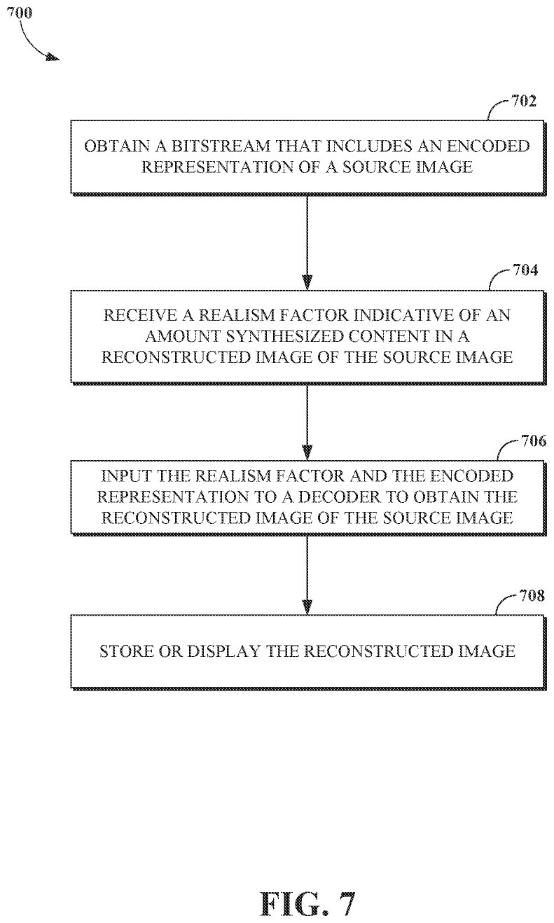

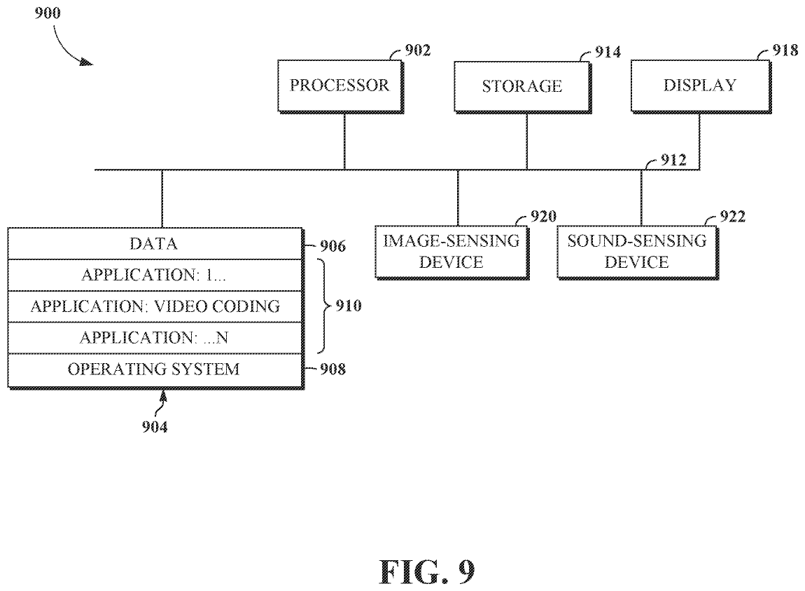

FIG. 7 is a flowchart of a method or technique 700 for obtaining a reconstructed image of a source image. The technique 700 can be implemented, for example, as a software program that may be executed by computing devices such as the computing device 900 of FIG. 9. The software program can include machine-readable instructions that may be stored in a memory such as the memory 904 or the secondary storage 914, and that, when executed by a processor, such as CPU 902, may cause the computing device to perform the technique 700. The technique 700 can be implemented using specialized hardware or firmware. Multiple processors, memories, or both, may be used.

At 702, a bitstream that includes an encoded representation of a source image is obtained. The encoded representation is a latent space representation of the source image and is generated by an encoder E, such as the encoder 504 of FIG. 5. The bitstream may be obtained via a compression process that includes a hyper-prior-based autoencoder.

At 704, a realism factor indicative of an amount synthesized content in a reconstructed image of the source image is received. The realism factor can be the realism factor 512 described with respect to FIG. 5. The realism factor can be a value in a range that includes a first value and a second value and other values between the first value and the second value, where the first value indicates that the reconstructed image includes no synthesized content and the second value indicates that the reconstructed image does not include synthesized content. Stated another way, the realism factor can be derived from a range of values indicative of desired perceptual qualities in the reconstructed image. In an example, the realism factor can be obtained as input from a user.

At 706, the realism factor and the encoded representation to a decoder to obtain the reconstructed image of the source image. The decoder can be a generator G of a Generative Adversarial Network (GAN). In an example, and as described with respect to FIG. 5, the generator can include a plurality of convolution layers and the realism factor can be injected into at least some of the convolution layers. At 708, the reconstructed image can be stored or displayed. The level of synthesized content in the reconstructed image can be based on the realism factor.

The technique 700 can include applying a machine-learning entropy model to the bitstream prior to obtaining the encoded representation.

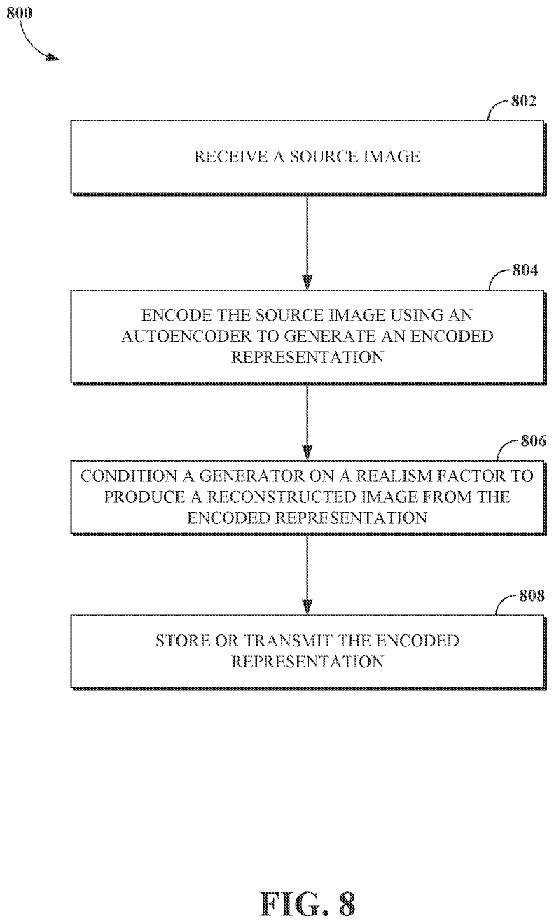

FIG. 8 is a flowchart of a method or technique 800 for encoding a source image such that different reconstructions can be obtained based on a realism factor. The technique 800 can be implemented, for example, as a software program that may be executed by computing devices such as the computing device 900 of FIG. 9. The software program can include machine-readable instructions that may be stored in a memory such as the memory 904 or the secondary storage 914, and that, when executed by a processor, such as CPU 902, may cause the computing device to perform the technique 800. The technique 800 can be implemented using specialized hardware or firmware. Multiple processors, memories, or both, may be used.

At 802, a source image is received. At 804, the source image is encoded using an autoencoder that includes a hyperprior-based architecture to generate an encoded representation.

At 806, a generator is conditioned on a realism factor to produce a reconstructed image from the encoded representation. The reconstructed image can vary from a low mean squared error (MSE) reconstruction to a high perceptual quality reconstruction based (e.g., depending) on the realism factor. The generator can be part of (e.g., trained as part of) a Generative Adversarial Network (GAN) and the reconstructed image is evaluated against a real image by a discriminator within the GAN. The generator can be trained using a loss function that includes a rate-distortion component and a realism component, as described above. At 808, the encoded representation is stored or transmitted.

As described with respect to FIG. 5, conditioning the generator on the realism factor to produce the reconstructed image from the encoded representation can include processing the realism factor through a feature-generator to obtain a set of realism-factor features and inputting the realism-factor features to the generator. The realism factor can be processed through a multilayer perceptron (MLP) to generate the realism-factor features.

FIG. 9 is a block diagram of an example of a computing device 900 (e.g., an apparatus). The computing device 900 may include one or more of an encoder (such as the encoder 504 of FIG. 5) or a decoder (such as the generator 508 of FIG. 5). The computing device 900 can obtain a source image, obtain an encoded representation using an encoder. The computing device 900 may store the encoded representation or transmit the encoded representation to another device. The computing device 900 may be a receiving device that receives (e.g., from another device or by fetching from a storage location) an encoded representation of a source image and can obtain a reconstruction of the source image using the decoder. The reconstructed image may be stored, displayed, re-transmitted, or the like.

The computing device 900 can be in the form of a computing system including multiple computing devices, or in the form of one computing device, for example, a mobile phone, a tablet computer, a laptop computer, a notebook computer, a desktop computer, and the like.

A CPU 902 in the computing device 900 can be a conventional central processing unit. Alternatively, the CPU 902 can be any other type of device, or multiple devices, capable of manipulating or processing information now existing or hereafter developed. Although the disclosed implementations can be practiced with one processor as shown, e.g., the CPU 902, advantages in speed and efficiency can be achieved using more than one processor.

A memory 904 in computing device 900 can be a read only memory (ROM) device or a random-access memory (RAM) device in an implementation. Any other suitable type of storage device can be used as the memory 904. The memory 904 can include code and data 906 that is accessed by the CPU 902 using a bus 912. The memory 904 can further include an operating system 908 and application programs 910, the application programs 910 including at least one program that permits the CPU 902 to perform the techniques described here. For example, the application programs 910 can include applications 1 through N, which further include a video coding application that performs the methods described here. Computing device 900 can also include a secondary storage 914, which can, for example, be a memory card used with a mobile computing device. Because the video communication sessions may contain a significant amount of information, they can be stored in whole or in part in the secondary storage 914 and loaded into the memory 904 as needed for processing.

The computing device 900 can also include one or more output devices, such as a display 918. The display 918 may be, in one example, a touch sensitive display that combines a display with a touch sensitive element that is operable to sense touch inputs. The display 918 can be coupled to the CPU 902 via the bus 912. Other output devices that permit a user to program or otherwise use the computing device 900 can be provided in addition to or as an alternative to the display 918. When the output device is or includes a display, the display can be implemented in various ways, including by a liquid crystal display (LCD), a cathode-ray tube (CRT) display or light emitting diode (LED) display, such as an organic LED (OLED) display.

The computing device 900 can also include or be in communication with an image-sensing device 920, for example a camera, or any other image-sensing device 920 now existing or hereafter developed that can sense an image such as the image of a user operating the computing device 900. The image-sensing device 920 can be positioned such that it is directed toward the user operating the computing device 900. In an example, the position and optical axis of the image-sensing device 920 can be configured such that the field of vision includes an area that is directly adjacent to the display 918 and from which the display 918 is visible.

The computing device 900 can also include or be in communication with a sound-sensing device 922, for example a microphone, or any other sound-sensing device now existing or hereafter developed that can sense sounds near the computing device 900. The sound-sensing device 922 can be positioned such that it is directed toward the user operating the computing device 900 and can be configured to receive sounds, for example, speech or other utterances, made by the user while the user operates the computing device 900.

Although FIG. 8 depicts the CPU 902 and the memory 904 of the computing device 900 as being integrated into one unit, other configurations can be utilized. The operations of the CPU 902 can be distributed across multiple machines (wherein individual machines can have one or more of processors) that can be coupled directly or across a local area or other network. The memory 904 can be distributed across multiple machines such as a network-based memory or memory in multiple machines performing the operations of the computing device 900. Although depicted here as one bus, the bus 912 of the computing device 900 can be composed of multiple buses. Further, the secondary storage 914 can be directly coupled to the other components of the computing device 900 or can be accessed via a network and can comprise an integrated unit such as a memory card or multiple units such as multiple memory cards. The computing device 900 can thus be implemented in a wide variety of configurations.

For simplicity of explanation, the technique 700 of FIG. 7 is depicted and described as a series of steps. However, steps in accordance with this disclosure can occur in various orders, concurrently, and/or iteratively. Additionally, steps in accordance with this disclosure may occur with other steps not presented and described herein. Furthermore, not all illustrated steps may be required to implement a technique in accordance with the disclosed subject matter.

The implementations herein may be described in terms of functional block components and various processing steps. The disclosed processes and sequences may be performed alone or in any combination. Functional blocks may be realized by any number of hardware and/or software components that perform the specified functions. For example, the described implementations may employ various integrated circuit components, e.g., memory elements, processing elements, logic elements, look-up tables, and the like, which may carry out a variety of functions under the control of one or more microprocessors or other control devices. Similarly, where the elements of the described implementations are implemented using software programming or software elements the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the implementations of the disclosure could employ any number of conventional techniques for electronics configuration, signal processing and/or control, data processing and the like.

Aspects or portions of aspects of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or a semiconductor device. Other suitable mediums are also available. Such computer-usable or computer-readable media can be referred to as non-transitory memory or media, and may include RAM or other volatile memory or storage devices that may change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. In other words, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” throughout is not intended to mean the same implementation or aspect unless described as such.

The particular aspects shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. Many alternative or additional functional relationships, physical connections or logical connections may be present in a practical device.

The use of “including” or “having” and variations thereof herein is meant to encompass the items listed thereafter and equivalents thereof as well as additional items. Unless specified or limited otherwise, the terms “mounted,” “connected,” ‘supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the disclosure (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed.

The above-described implementations have been described in order to allow easy understanding of the present disclosure and do not limit the present disclosure. To the contrary, the disclosure is intended to cover various modifications and equivalent arrangements included within the scope of the appended claims, which scope is to be accorded the broadest interpretation so as to encompass all such modifications and equivalent structure as is permitted under the law.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A method, comprising:
obtaining a bitstream that includes an encoded representation of a source image;
receiving a realism factor indicative of an amount of synthesized content in a reconstructed image of the source image;
inputting the realism factor and the encoded representation to a decoder to obtain the reconstructed image of the source image; and
storing or displaying the reconstructed image.

2. The method of claim 1, wherein the encoded representation comprises a latent space representation of the source image and is created by an encoder.

3. The method of claim 1, wherein the decoder is a generator of a Generative Adversarial Network (GAN).

4. The method of claim 3, wherein the realism factor is obtained as input from a user.

5. The method of claim 3, wherein the generator includes a plurality of convolution layers, and wherein the realism factor is injected into at least some of the convolution layers.

6. The method of claim 1, wherein the realism factor is a value in a range that includes a first value and a second value and other values between the first value and the second value, wherein the first value indicates that the reconstructed image includes no synthesized content and the second value indicates that the reconstructed image does not include synthesized content.

7. The method of claim 1, wherein a level of synthesized content in the reconstructed image is based on the realism factor.

8. The method of claim 1, wherein the bitstream is obtained via a compression process that includes a hyper-prior-based autoencoder.

9. The method of claim 1, further comprising:
applying a machine-learning entropy model to the bitstream prior to obtaining the encoded representation.

10. The method of claim 1, wherein the realism factor is derived from a range of values indicative of desired perceptual qualities in the reconstructed image.

11. A method, comprising:
receiving a source image;
encoding the source image using an autoencoder to generate an encoded representation, wherein the autoencoder comprises a hyperprior-based architecture;
conditioning a generator on a realism factor to produce a reconstructed image from the encoded representation, wherein the realism factor is adjustable to control a level of synthesized content in the reconstructed image; and
storing or transmitting the encoded representation.

12. The method of claim 11, wherein conditioning the generator on the realism factor to produce the reconstructed image from the encoded representation comprises:
processing the realism factor through a feature-generator to obtain a set of realism-factor features; and
inputting the realism-factor features to the generator.

13. The method of claim 12, processing the realism factor through the feature-generator to obtain the set of the realism-factor features comprises:
processing the realism factor through a multilayer perceptron (MLP) to generate the realism-factor features.

14. The method of claim 11, wherein the reconstructed image varies from a low mean squared error (MSE) reconstruction to a high perceptual quality reconstruction based on the realism factor.

15. The method of claim 11, wherein the generator is part of a Generative Adversarial Network (GAN), and wherein the reconstructed image is evaluated against a real image by a discriminator within the GAN.

16. The method of claim 15, wherein the generator is trained using a loss function that includes a rate-distortion component and a realism component.

17. A device, comprising:
a processor that is configured to perform the method of claim 1.

18. (canceled)

19. A non-transitory computer-readable storage medium, comprising executable instructions that, when executed by a processor, cause performance of operations that perform a method comprising:
obtaining a bitstream that includes an encoded representation of a source image;
receiving a realism factor indicative of an amount of synthesized content in a reconstructed image of the source image;
inputting the realism factor and the encoded representation to a decoder to obtain the reconstructed image of the source image; and
storing or displaying the reconstructed image.

20. (canceled)

21. A device, comprising:
a memory; and
a processor, the processor configured to execute instructions stored in the memory to perform the method of claim 11.

22. (canceled)

23. The device of claim 17, wherein the decoder is a generator of a Generative Adversarial Network (GAN).
